(19) United States
(12) Patent Application Publication
(10) Pub. No.: US 2022/0256905 A1
(43) Pub. Date: Aug. 18, 2022

(54) FOOD MOLD AND METHOD FOR FOOD PROCESSING USING THE SAME

(71) Applicant: YO-KAI EXPRESS INC., Sunnyvale, CA (US)

(72) Inventor: Chih Hung LIN, San Jose, CA (US)

(73) Assignee: YO-KAI EXPRESS INC., Sunnyvale, CA (US)

(21) Appl. No.: 17/733,711

(22) Filed: Apr. 29, 2022

Related U.S. Application Data
(63) Continuation of application No. 16/997,664, filed on Aug. 19, 2020.
(60) Provisional application No. 62/890,700, filed on Aug. 23, 2019.

(51) Int. Cl. A23P 30/10; A47J 43/20

(52) U.S. Cl. CPC A23P 30/10; A47J 43/20

(57) ABSTRACT

Provided herein are a food mold for use in food processing and a method for food processing using the food mold. The food mold includes a bottom portion, a sidewall and a protruding structure. The bottom portion includes a peripheral edge and a bottom surface. The peripheral edge surrounds the bottom surface. The sidewall includes a lower edge and an upper edge opposite to the lower edge. The sidewall surrounds the bottom portion. The lower edge is connected to the peripheral edge. The protruding structure is disposed on the bottom surface.

### CROSS REFERENCE

This application is a Continuation of copending application Ser. No. 16/997,664, filed on Aug. 19, 2020, which claims priority under 35 U.S.C. § 119(e) to U.S. Provisional Application No. 62/890,700, filed on Aug. 23, 2019, all of which are hereby expressly incorporated by reference into the present application.

### FIELD OF THE INVENTION

The present disclosure relates to the food processing technology and, more particularly, to a food mold for use in food processing and a method for food processing using the food mold.

### BACKGROUND OF THE INVENTION

Heat-and-eat food made of wheat or rice is usually processed and packaged in packs for sale for one consumer or few consumers. Tedious cooking procedures are not required for a consumer to enjoy such heat-and-eat food. All he/she has to do is heat up the heat-and-eat food using simple procedures such as microwave heating or hot water heating. During food processing, most food manufacturers process and shape food into blocks such that the block-shaped food can be placed in food containers and then packaged for display and sale in the market. For example, instant noodles that are edible when brewed in hot water and noodles that need to be boiled first, and then mixed with sauce to be edible both belong to this kind of heat-and-eat food. Therefore, heat-and-eat food is quite popular among the public in the fast and busy modern life.

In the prior art, most heat-and-eat food is presented in a dense block shape, which leads to some heating problems such as incomplete heating due to uneven heating of the food itself or lengthy heating process.

### SUMMARY OF THE INVENTION

In view of the above, one object of the present disclosure is to provide a food mold for use in food processing, which is capable of enhancing heating efficiency when heating heat-and-eat food to overcome the problems of incomplete heating due to uneven heating of the food itself or lengthy heating process.

One further object of the present disclosure is to provide a method for food processing, which is capable of enhancing heating efficiency when heating heat-and-eat food to overcome the problems of incomplete heating due to uneven heating of the food itself or lengthy heating process.

In one aspect, the present disclosure provides a food mold including a bottom portion, a sidewall and a protruding structure. The bottom portion includes a peripheral edge and a bottom surface. The peripheral edge surrounds the bottom surface. The sidewall includes a lower edge and an upper edge opposite to the lower edge. The sidewall surrounds the bottom portion. The lower edge is connected to the peripheral edge. The protruding structure is disposed on the bottom surface.

In one embodiment of the present disclosure, the protruding structure includes a first post centrally disposed on the bottom surface.

In one embodiment of the present disclosure, the protruding structure further includes plural second posts disposed on the bottom surface and surrounding the first post.

In one embodiment of the present disclosure, the protruding structure further includes plural ribs disposed on the bottom surface. Each of the plural ribs has an end connected to the first post and the other end connected to a corresponding one of the second posts.

In one embodiment of the present disclosure, the second posts are spaced apart equidistantly.

In one embodiment of the present disclosure, the first post has a first height relative to the bottom surface, each of the second posts has a second height relative to the bottom surface, and the first height is higher than the second height.

In one embodiment of the present disclosure, the first post has a first diameter on the bottom surface, each of the second posts has a second diameter on the bottom surface, and the first diameter is larger than the second diameter.

In one embodiment of the present disclosure, the food mold further includes a brim portion surrounding the sidewall and being connected to the upper edge.

In one embodiment of the present disclosure, the brim portion extends from the upper edge in a direction away from the sidewall.

In one embodiment of the present disclosure, the peripheral edge and the sidewall take on wavy outlines from a projective perspective.

In one embodiment of the present disclosure, the bottom surface has plural through holes.

In one further aspect, the present disclosure provides a method for food processing, and the method includes the following steps. A food mold including a bottom portion, a sidewall and a protruding structure is first provided. A mixed edible material is then placed in the food mold before the mixed edible material is fully hardened such that the protruding structure is inserted into the mixed edible material. The mixed edible material is removed from the food mold after the mixed edible material becomes slightly or fully hardened such that the mixed edible material corresponds in shape to the bottom portion and the sidewall.

In one embodiment of the present disclosure, the mixed edible material form a central channel centrally therein and the central channel corresponds in shape, outline and size to the first post.

In one embodiment of the present disclosure, the protruding structure further comprises a plurality of second posts disposed on the bottom surface and surrounding the first post such that the mixed edible material forms peripheral channels around the central channel, and the peripheral channels correspond in shape, outline and size to the second posts.

In one embodiment of the present disclosure, the protruding structure further comprises a plurality of ribs disposed on the bottom surface, each of the plurality of ribs having an end connected to the first post and the other end connected to a corresponding one of the second posts, such that the mixed edible material forms thereon dent channels connecting the central channel to the peripheral channels, and the dent channels correspond in shape, outline and size to the ribs.

In one embodiment of the present disclosure, the second posts are spaced apart equidistantly such that the peripheral channels are spaced apart equidistantly.

In one embodiment of the present disclosure, the first post has a first height relative to the bottom surface, each of the second posts has a second height relative to the bottom surface, and the first height is higher than the second height, such that the central channel is deeper than the peripheral channels.

In one embodiment of the present disclosure, the first post has a first diameter on the bottom surface, each of the second posts has a second diameter on the bottom surface, and the first diameter is larger than the second diameter, such that the central channel is wider than the peripheral channels.

In conclusion, after the mixed edible food is processed and shaped with the food mold in one embodiment of the present disclosure, the processed, shaped food forms therein one or more channels. The channels are conducive to the passage of steam or hot water through the processed, shaped food and thereby enhance its cooking efficiency, so as to cook the food uniformly, fully and speedily.

Fine features and advantages of the present disclosure are described in detail below to enable persons skilled in the art to understand and implement the technical features of the present disclosure. Persons skilled in the art may refer to the specification, claims and drawings of the present disclosure and thereby easily understand the objectives and advantages of the present disclosure.

### BRIEF DESCRIPTION OF THE DRAWINGS

The foregoing summary, as well as the following detailed descriptions of the invention, will be better understood when read in conjunction with the appended drawings. In the drawings:

FIG. 1 is a schematic view of a food mold according to one embodiment of the present disclosure;

FIG. 2 is a top view of the food mold shown in FIG. 1;

FIG. 3 is a cross-sectional view of the food mold taken along line 3-3 of FIG. 2;

FIG. 4 is a cross-sectional view of the food mold taken along line 4-4 of FIG. 2; and

FIG. 5 is a picture taken of a food container for containing food to be processed with the food mold of FIG. 1 according to one embodiment of the present disclosure.

### DESCRIPTION OF THE INVENTION

The following embodiments when read with the accompanying drawings are made to clearly exhibit the above-mentioned and other technical contents, features and effects of the present disclosure. Through the exposition by means of the specific embodiments, people would further understand the technical means and effects of the present disclosure adopted to achieve the above-indicated objectives. Moreover, as the contents disclosed herein can be readily understood and implemented by a person skilled in the art, all equivalent changes or modifications which do not depart from the concept of the present disclosure shall be encompassed by the appended claims.

Furthermore, the ordinals recited in the specification and the claims such as “first”, “second” and so on are intended only to describe the elements claimed and imply or represent neither that the claimed elements have any proceeding ordinals, nor the sequence between one claimed element and another claimed element or between steps of a manufacturing method. The use of these ordinals is merely to differentiate one claimed element having a certain designation from another claimed element having the same designation.

Furthermore, the terms recited in the specifications and the claims such as “above”, “over”, or “on” are intended not only directly contact with the other element, but also intended indirectly contact with the other element.

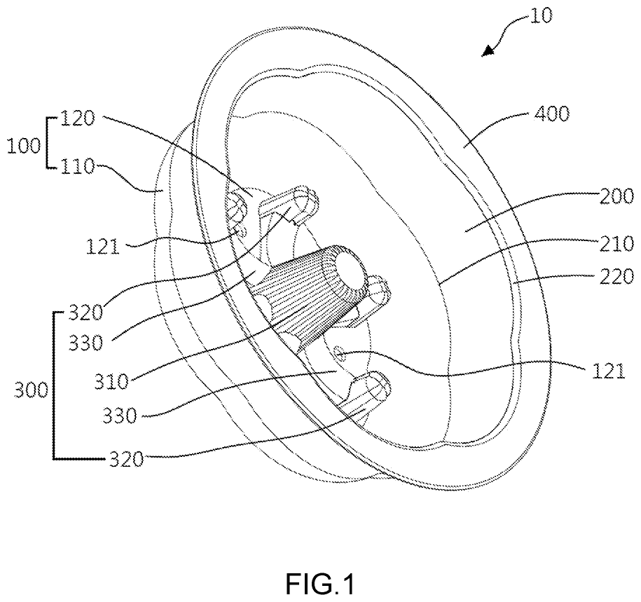

Referring to FIG. 1, FIG. 1 is a schematic view of a food mold 10 according to one embodiment of the present disclosure. In this embodiment, the food mold 10 is food mold for use in food processing to manufacture heat-and-eat food. The heat-and-eat food is a mixed edible material including, but is not limited to, noodles, rice, dried vegetables, frozen food (such as soups) or a composition thereof and is shaped by the food mold 10. The food mold 10 includes a bottom portion 100, a sidewall 200, and a protruding structure 300. The bottom portion 100 includes a peripheral edge 110 and a bottom surface 120. The peripheral edge 110 surrounds the bottom surface 120. The sidewall 200 includes a lower edge 210 and an upper edge 220 opposite to the lower edge 210. The sidewall 200 surrounds the bottom portion 100. The lower edge 210 is connected to the peripheral edge 110. The bottom portion 100 and the sidewall 200 jointly define a receiving space for the food. The protruding structure 300 is disposed on the bottom surface 120. The protruding structure 300 is disposed in the receiving space. The protruding structure 300 extends from the bottom surface 120 to the receiving space. In this embodiment, the bottom portion 100, the sidewall 200 and the protruding structure 300 are integrally formed in one piece, but the present disclosure is not limited thereto.

For example, the mixed edible material is placed in the food mold 10 before it is fully hardened so as to be shaped. Meanwhile, the protruding structure 300 is inserted into the mixed edible material. After the mixed edible material becomes slightly or fully hardened, the mixed edible material is removed from the food mold 10. After being processed and shaped, the mixed edible material corresponds in shape to the bottom portion 100 and the sidewall 200. The mixed edible material forms channels therein because of the protruding structure 300. The channels correspond in position and shape to the protruding structure 300 and are conducive to the passage of a heating medium, such as steam or hot water, through the mixed edible material.

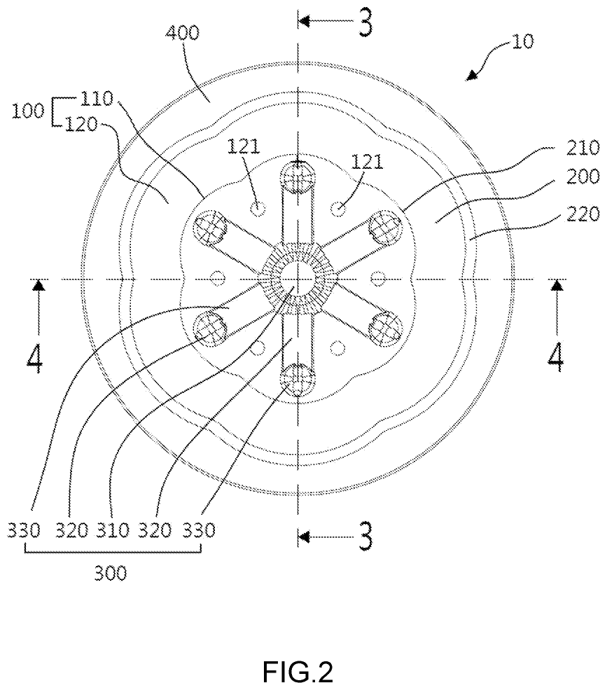

Referring to FIG. 2, FIG. 2 is a top view of the food mold 10 shown in FIG. 1. As shown in FIG. 1 and FIG. 2, in this embodiment, the protruding structure 300 includes a first post 310. The first post 310 is centrally disposed on the bottom surface 120. After being processed and shaped with the food mold 10, the mixed edible material form centrally therein a central channel because of the first post 310. The central channel corresponds in shape, outline and size to the first post 310.

As shown in FIG. 1 and FIG. 2, in this embodiment, the protruding structure 300 further includes plural second posts 320. The second posts 320 are disposed on the bottom surface 120. The second posts 320 surround the first post 310 and are at substantially equal distances from the first post 310. In this embodiment, the second posts 320 are spaced apart equidistantly, but the present disclosure is not limited thereto. After being processed and shaped with the food mold 10, the mixed edible material forms peripheral channels around the mixed edible material because of the second posts 320. The peripheral channels surround the central channel. In this embodiment, the peripheral channels are spaced apart equidistantly, but the present disclosure is not limited thereto. The peripheral channels correspond in shape, outline and size to the second posts 320.

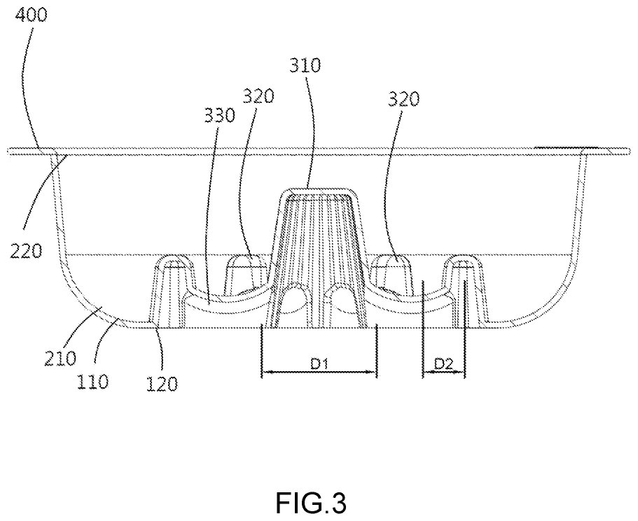

Referring to FIG. 3, FIG. 3 is a cross-sectional view of the food mold 10 taken along line 3-3 of FIG. 2. As shown in FIG. 1 through FIG. 3, in this embodiment, the protruding structure 300 further includes ribs 330. The ribs 330 are disposed on the bottom surface 120 and extend toward the receiving space. Each rib 330 has one end connected to the first post 310 and the other end connected to a corresponding one of the second posts 320. After being processed and shaped with the food mold 10, the mixed edible material forms thereon dent impressions or dent channels because of the ribs 330. The dent impressions connect the central channel to the peripheral channels. The dent impressions correspond in shape, outline and size to the ribs 330.

As shown in FIG. 2, in this embodiment, from a projective perspective, the ribs 330 radially extend outward from the first post 310, and each rib 330 is connected to a corresponding one of the second posts 320. As shown in FIG. 2, in this embodiment, from a projective perspective, the peripheral edge 110 and the sidewall 200 take on wavy outlines.

As shown in FIG. 3, in this embodiment, the first post 310 has a first diameter D1 on the bottom surface 120, whereas each second post 320 has a second diameter D2 on the bottom surface 120. The first diameter D1 is greater than the second diameter D2, but the present disclosure is not limited thereto. In this embodiment, the central channel of the mixed edible material is wider than the peripheral channels, but the present disclosure is not limited thereto. As shown in FIG. 3, in this embodiment, the diameter of the first post 310 and the diameter of the second posts 320 decrease away from the bottom surface 120. As shown in FIG. 3, in this embodiment, the lower edge 210 of the sidewall 200 transitionally is connected to the peripheral edge 110 of the bottom portion 100, and therefore the lower edge 210 is arcuate.

As shown in FIG. 1 through FIG. 3, in this embodiment, the food mold 10 further includes a brim portion 400. The brim portion 400 corresponds in position to the sidewall 200 and is connected to the upper edge 220 of the sidewall 200. In this embodiment, the brim portion 400 extends outward from the upper edge 220 in a direction away from the sidewall 200. The included angle between the brim portion 400 and the upper edge 220 is substantially 90 degrees, but the present disclosure is not limited thereto.

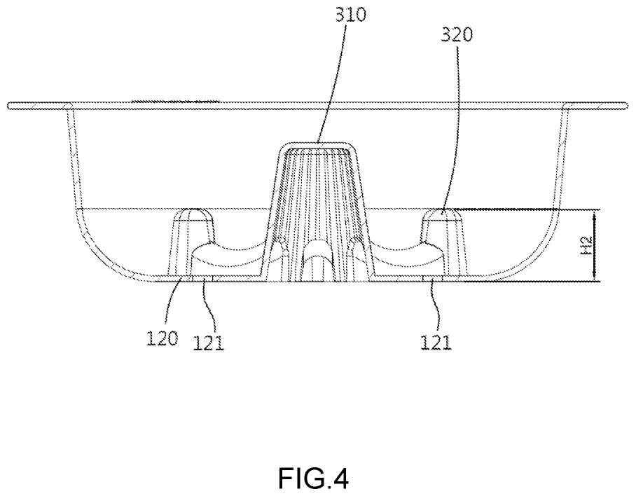

Referring to FIG. 4, FIG. 4 is a cross-sectional view of the food mold 10 taken along line 4-4 of FIG. 2. As shown in FIG. 4, in this embodiment, the first post 310 has a first height H1 relative to the bottom surface 120, whereas each second post 320 has a second height H2 relative to the bottom surface 120. The first height H1 is greater than the second height H2, but the present disclosure is not limited thereto. In this embodiment, the central channel of the mixed edible material is deeper than the peripheral channels, but the present disclosure is not limited thereto. In a variant embodiment, the first height H1 of the first post 310 is less than or equal to the second height H2 of the second posts 320. In another variant embodiment, the first diameter D1 of the first post 310 is less than or equal to the second diameter D2 of the second posts 320.

As shown in FIG. 1, FIG. 2 and FIG. 4, in this embodiment, the bottom surface 120 has a plurality of through holes 121. The through holes 121 penetrate the bottom surface 120. In the course of processing and shaping the mixed edible material with the food mold 10, not only are the through holes 121 conducive to ventilation but residual liquid of the mixed edible material is also discharged from the food mold 10 via the through holes 121, thereby speeding up the processing and shaping process.

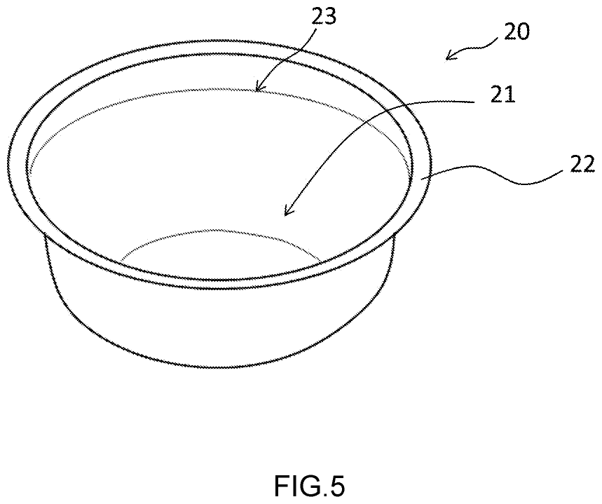

Referring to FIG. 5, a food container 20 in one embodiment of the present disclosure contains the heat-and-eat food processed with the food mold 10 of FIG. 1. After being processed and shaped with the food mold 10, the heat-and-eat food forms impressions of dents and channels, which correspond in position to the first post 310, the ribs 330 and the second posts 320, and penetrate or do not penetrate the heat-and-eat food. Afterward, the heat-and-eat food is placed in the food container 20 shown in FIG. 5 for packaging.

The food container 20 includes a receiving space 21, a rim 22 and an opening 23. After being processed and shaped with the food mold 10, the heat-and-eat food is placed in the receiving space 21 of the food container 20. Then, the opening 23 is covered with specific packaging film, and the edges of the packaging film are fixed to the rim 22, so as to hermetically seal the receiving space 21. To cook the heat-and-eat food, a consumer places the food container 20 in a food heater such that an injection element of the food heater penetrates the packaging film and then injects steam and hot water into the receiving space 21. As mentioned before, the heat-and-eat food now has channels and impressions corresponding in position to the first post 310, the ribs 330 and the second posts 320, and in consequence the steam and hot water pass through the channels and impressions so as to be uniformly distributed throughout the heat-and-eat food.

In conclusion, a food mold and a method for food processing using the food mold are provided in the present disclosure. After being processed and shaped with the food mold, heat-and-eat food forms thereon one or more channels and dent impressions. The channels and impressions are conducive to the passage of steam and/or hot water through the heat-and-eat food such that the cooking efficiency of the heat-and-eat food is enhanced, so as to cook the heat-and-eat food uniformly, fully and speedily.

Although the present disclosure is disclosed above by preferred embodiments, the preferred embodiments are not restrictive of the present disclosure. Changes and modifications made by persons skilled in the art to the preferred embodiments without departing from the spirit of the present disclosure must be deemed falling within the scope of the present disclosure. Accordingly, the legal protection for the present disclosure should be defined by the appended claims.

What is claimed is:

1. A food mold, comprising:
a bottom portion comprising a peripheral edge and a bottom surface, the peripheral edge surrounding the bottom surface;
a sidewall comprising a lower edge and an upper edge opposite to the lower edge, wherein the sidewall surrounds the bottom portion, the lower edge is arcuate and connected to the peripheral edge, and each of the peripheral edge and the lower edge is not circular from a top view; and
a protruding structure disposed on the bottom surface, wherein the protruding structure comprises:
a first post centrally disposed on the bottom surface;
a plurality of second posts disposed on the bottom surface and surrounding the first post; and
a plurality of ribs disposed on the bottom surface, the plurality of ribs respectively corresponding to the plurality of second posts, each of the plurality of ribs having an end connected to the first post and the other end connected to a corresponding one of the second posts, wherein all of the plurality of the second posts are connected to the first post via the plurality of ribs, each of the plurality of ribs has a consistent width from the end connected to the first post and the other end connected to the corresponding one of the second posts, and a top surface of each of the plurality of ribs is curved bending toward the bottom surface,
wherein the first post has a first height relative to the bottom surface, each of the second posts has a second height relative to the bottom surface, and the first height is higher than the second height,
wherein the sidewall has a third height relative to the bottom surface, each of the plurality of ribs has a maximum height relative to the bottom surface, the third height is higher than the first height, the first height is larger than a half of the third height, the second height is less than a half of the third height, and the maximum height is lower than the second height,
wherein the first post has a first diameter on the bottom surface, each of the second posts has a second diameter on the bottom surface, and the first diameter is larger than the second diameter,
wherein each of the plurality of ribs has the width substantially equal to the second diameter of the corresponding one of the second posts from the top view, and
wherein the sidewall including the upper edge and lower edge, the bottom surface, the plurality of second posts, the plurality of ribs and the first post are integrally formed as one single and monolithic piece.

2. The food mold of claim 1, wherein the second posts are spaced apart equidistantly.

3. The food mold of claim 1, further comprising a brim portion surrounding the sidewall and being connected to the upper edge.

4. The food mold of claim 3, wherein the brim portion extends from the upper edge in a direction away from the sidewall.

5. The food mold of claim 1, wherein the peripheral edge and the sidewall take on wavy outlines from a projective perspective, wherein the wavy outlines have the form of identical waves, each comprising a fold opening toward inside of the mold.

6. The food mold of claim 1, wherein the bottom surface has a plurality of through holes.

7. A method for food processing, comprising the steps of:
providing a food mold according to claim 1;
placing a mixed edible material in the food mold before the mixed edible material is fully hardened such that the protruding structure is inserted into the mixed edible material; and
removing the mixed edible material from the food mold after the mixed edible material becomes slightly or fully hardened such that the mixed edible material corresponds in shape to the bottom portion and the sidewall.

8. The method for food processing of claim 8, further comprising the steps of:
providing a food container including a receiving space and an opening;
placing the mixed edible material removed from the food mold into the receiving space of the food container;
covering the opening of the food container with a film; and
heating the food container by penetrating the film with an injection element and injecting steam and hot water into the receiving space, so that the steam and hot water pass through channels and impressions caused by the first post, the plurality of second posts and the plurality of ribs so as to be distributed throughout the mixed edible material.

9. The method for food processing of claim 8, further comprising the step of forming a central channel centrally in the mixed edible material, wherein the central channel corresponds in shape, outline and size to the first post.

10. The method for food processing of claim 9, further comprising the step of forming peripheral channels in the mixed edible material around the central channel, wherein the peripheral channels correspond in shape, outline and size to the second posts.

11. The method for food processing of claim 10, further comprising the step of forming dent channels connecting the central channel to the peripheral channels in the mixed edible material, wherein the dent channels correspond in shape, outline and size to the ribs.

12. The method for food processing of claim 10, wherein the second posts are spaced apart equidistantly such that the peripheral channels are spaced apart equidistantly.

13. The method for food processing of claim 10, wherein the central channel is deeper than the peripheral channels.

14. The method for food processing of claim 10, wherein the central channel is wider than the peripheral channels.
